(19) United States
(12) Patent Application Publication
(10) Pub. No.: US 2013/0280518 A1
(43) Pub. Date: Oct. 24, 2013

(54) BUILDING MATERIAL AND BUILDING SYSTEM ELEMENT AS WELL AS METHOD OF PRODUCTION THEREOF

(71) Applicants: Beat Stähli, Schupfen (CH); Gerhard Rytz, Bern (CH); Beat Ruchti, Lyss (CH)

(72) Inventors: Beat Stähli, Schupfen (CH); Gerhard Rytz, Bern (CH); Beat Ruchti, Lyss (CH)

(73) Assignee: VICAT, Paris la Défense (FR)

(21) Appl. No.: 13/821,096

(22) PCT Filed: Jun. 17, 2011
(86) PCT No.: PCT/EP11/60159

§ 371 Date: Mar. 28, 2013

(30) Foreign Application Priority Data
Sep. 16, 2010 (CH) 01492/10

(51) Int. Cl. C04B 22/04; B29C 44/12; E04C 1/40

(52) U.S. Cl. CPC C04B 22/04; E04C 1/40; B29C 44/12
USPC 428/312.4; 264/45.3; 106/641

(57) ABSTRACT

The invention relates to a building material (M2), which can be produced by combining 30 to 70% by weight of a cement or respectively hydraulic binder, 20 to 80% by weight of water and 0.05 to 15% by weight of a porous and/or pore-forming material; or by combining 10 to 80% by weight of a cement or respectively hydraulic binder, 10 to 80% by weight of a pulverulent and/or granular mineral filler, 20 to 80% by weight of water and 0.05 to 15% by weight of a porous and/or pore-forming material; and in each case by subsequent mixing of the combined components for 1 to 15 minutes. The invention furthermore relates to a building system element (1; 2) with a first section (11; 21) containing particularly compact solid particles distributed in a hardened cement matrix (M1) and fixed thereby, and with a second section (12; 22) containing pores distributed in a hardened cement matrix (M2). This second section (12; 22) can be composed of the building material (M2) according to the invention.

The invention relates to a building material and a building system element containing this building material as well as to methods for production of this building material or respectively building system element. Building materials and building system elements containing these find application in construction of structures or structural parts, in particular of buildings, walls, facades, ceilings, floors, etc.

Numerous building materials are known whose basic material is an inorganic or respectively cementitious binder, in which air pockets are incorporated during the production before hardening of the still soft cement mass in order to reduce the density of the building material thus produced as well as to increase its thermal insulation, humidity insulation and sound insulation.

EP 0 647 603 describes a fine-pored building material, the pores of which have a diameter of under 5 μm. The production takes place on the basis of a cement/water mixture with a cement/water ratio of about 0.24 to 0.40 and with addition of a surfactant. This mixture is mixed or respectively “beaten” by means of a high turbulence mixer (blade agitator) at 1500 rpm, whereby air bubbles are introduced and are broken up into smaller air bubbles. The cement mass thus obtained is cast in molds, where it hardens at ambient temperature.

U.S. Pat. No. 5,110,084 describes a method for production of a fine-pored building material on the basis of a cement/water mixture with a water/cement ratio of about 0.5 at a temperature of about 60° C., into which is mixed a frother solution (stabilized foam) of about the same temperature in order to generate the air bubbles in the cement mass. The thus obtained porous cement mass is poured into heat-insulated molds in which the hardening takes place at slowly falling temperature.

The known methods are complex or energy-intensive, and often achieve no satisfactory insulation characteristics for heat, humidity and sound.

The object of the invention is to provide an inexpensive and energy-efficient method for production of a building material that combines therein good insulation features for heat, humidity and sound.

The invention provides a method for production of a building material having, in a first variant, the following steps:
Combining 30 to 70% by weight of a cement or respectively hydraulic binder, 20 to 80% by weight of water and 0.05 to 15% by weight of porous and/or pore-forming material; and
Mixing of the combined components for 1 to 15 minutes.

The mixing can take place in a mixer, the sequence of feeding of the components being in any order. In particular, the components can also be fed simultaneously.

Preferably the method is as follows:
Combining 51 to 71% by weight of a cement of the class CEM I or of the class CEM II, 28 to 48% by weight of water and 0.05 to 5% by weight of aluminum paste and/or aluminum powder; and
Mixing of the combined components for 1 to 15 minutes.

The invention provides a method for production of a building material having, according to a second variant, the following steps:
Combining 10 to 80% by weight of a cement or respectively hydraulic binder, 10 to 80% by weight of pulverulent and/or granular mineral filler, 20 to 80% by weight of water and 0.05 to 15% by weight of porous and/or pore-forming material; and
Mixing of the combined components for 1 to 15 minutes.

Preferably the method is as follows:
Combining 15 to 35% by weight of a cement of the class CEM I or of the class CEM II, 10 to 40% by weight of pulverulent mineral filler, 38 to 48% by weight of water and 0.05 to 5% by weight of aluminum paste and/or aluminum powder; and
Mixing of the combined components for 1 to 15 minutes.

The building material according to the invention produced according to this method has preferably a pore volume percentage of 20 to 70%, there being especially preferably a majority of the total volume, 70 to 95%, in particular more than 80%, in the form of pores whose diameter (“size”) is in the range of 0.1 to 5 mm and in particular in the range of 0.2 to 2 mm. With these pore sizes it is especially advantageous when the particle size distribution of the mineral filler is in the range of 0 to 200 μm and preferably in the range of 0 to 100 μm.

Preferably the thus produced building material has a density in the range of 400 to 800 kg/m³ and preferably in the range of 500 to 600 kg/m³.

The building material according to the invention produced with these features has a thermal conductivity in the range of 0.1 to 0.2 W/(m·K) and in particular in the range of 0.12 to 0.16 W/(m·K), and thereby makes possible at the same time an excellent humidity insulation and sound insulation, is able to be handled well (sawing, drilling) and is mechanically and chemically durable.

There are known building system elements with a first section containing particularly compact solid particles distributed in a hardened cement matrix and fixed thereby, and a second section containing pores distributed in a hardened cement matrix, the first section and the second section being connected.

Such a building system element is known from e.g. EP 1 988 228 or from EP 0 049 348.

The present invention also provides a building system element of the described type of construction, in which the second section is formed as porous cement matrix by foamed cement paste and/or cement paste intermixed with hollow solid particles and subsequently hardened.

The invention provides, on the other hand, a method for production of such a building system element.

In a preferred embodiment, in the building system element according to the invention, the first section is a composite of stone particles or respectively aggregates and cement, and, to be more precise, in particular with grit, gravel, round grained sand or crushed sand or mixtures thereof distributed in a cement matrix. This concrete-type first section preferably contains stone particles of different sizes so that in the material of the first section the volume portion of the stone particles in relation to the total volume, i.e. the volume of the stone particles plus the volume of the cement matrix, is between 70% and 99%, preferably between 80% and 95%. This first section or respectively “concrete section” is especially pressure-resistant and hard. It therefore provides stability for the building system element and thus of the structure or structural part built from such elements. A portion or all of these stone particles can also be replaced by particles of fired clay, i.e. brick particles, steam-hardened particles, such as e.g. calcareous sandstone particles, particles obtained from stone material, melted or baked on and then allowed to solidify, e.g. glass particles. Alternatively, or additionally, besides the stone particles, metal particles or polymer particles can also be admixed with the first material of the first section. The mentioned inorganic solid particles and the cement matrix are predominantly connected to one another in a material-bonding way (crystallization bridges). Depending upon the properties and condition of the surface of these particles, e.g. depending upon their surface roughness, formfitting connections exist between the solid particles and the cement matrix. In an especially preferred embodiment, the glass portions and/or polymer portions and/or metal portions, admixed in addition to the stone particles, have the form of fibers, which are preferably roughened and are thus embedded in a formfitting way in the cement matrix in addition to the stone particles. These additional components increase the strength of the material of the first section.

Rock flour can be added to the material of the second section formed by the porous cement matrix. Understood by rock flour in this context is a rock powder with a grain size distribution of 0 to 500 μm, preferably with a grain size distribution of 0 to 300 μm. According to an especially preferred embodiment, for production of the porous cement matrix, a mass is created, particularly conveyable and shapeable through pressing, pouring or casting or pumping, made of cement and water as well as, where appropriate, the mentioned rock flour. Added to this mass are preferably chemically acting (through reaction of the gas arising from admixed components) and/or physically acting (through admixed gas and its heating and/or reduction of the ambient pressure) expanding agents. To increase the viscosity of the cement paste, water-soluble or at least water-swellable polymers, such as e.g. starch, can be admixed. It is especially advantageous if admixed with the cement mass or respectively the cement paste is additionally aluminum powder or an aluminum paste, the aluminum contained therein reacting together with the water to form aluminum oxide and hydrogen. The thereby formed aluminum oxide acts as an additional binder, and the thereby formed hydrogen acts as gaseous expanding agent for pore formation in the cement matrix. A porous cement paste foamed through physical and/or chemical expanding agents is then obtained as the material for the second section. Preferably the addition of the aluminum powder or of the aluminum paste takes place before addition of the water. The aluminum powder or respectively the aluminum paste is then mixed together with the other components in a dry blending step.

In a first variant of the building system element according to the invention, the first section is in the form of a hollow block shape with one or more cavities, and the second section is formed by the one or more cavities, which is, or respectively are, filled with the foamed cement paste and/or cement paste intermixed with hollow solid particles and hardened. This first variant is thus a hollow concrete block with cement paste foaming out.

In a second variant of the building system element according to the invention, the first section is in the form of a first plate formation and the second section is in the form of a second plate formation, these two plate formations being each fixed to one another by one of their large faces. This second variant is thus a concrete plate with cement paste foaming on. Especially preferred is that this second variant be a multilayered formation (sandwich), and to be more precise, with at least two layers of the type of the first plate formation (high compression resistance, of concrete type) with a layer disposed in between of the type of the second plate formation (of cement paste type), or vice versa with at least two layers of the type of the second plate formation (of cement paste type) with a layer disposed in between of the type of the first plate formation (high compression resistance, of concrete type). A multiplicity of such plate formations of the first type and second type can also be disposed successively in an alternating way, i.e. at least two of the first type and at least two of the second type in a way alternating with one another, such as e.g. according to the plan type 1-type 2-type 1-type 2-type 1. This multilayered construction technique or respectively sandwich construction technique makes possible new degrees of freedom or respectively design possibilities in that the number of layers of the first type and second type as well as their respective thickness can be adapted to the respective requirements. Above all with respect to the optimization of the barrier features for heat, sound and humidity with simultaneous optimization its dimensions or weight, this special embodiment of the building system element according to the invention opens up new possibilities.

The cement paste foaming out and the cement paste foaming on in the first variant or respectively in the second variant constitute a very effective barrier against heat conduction, against sound propagation and against dispersion of humidity in the building system element according to the invention.

To obtain a good mechanical connection between the first section (of concrete type) and the second section (cement paste type), it is advantageous if the material of the first section and the material of the second section abut one another in a flat way. Preferably the material of the first section is connected together with the material of the second section in a formfitting and/or material-bonding way,

The formfit occurs through formations complementary to one another on the interfaces turned toward one another and contacting one another of the first and of the second section. Expediently the surface of the first section turned toward the second section has elevations which project into the material of the second section and are surrounded thereby, and/or depressions into which the material of the second section projects and fills out.

The material connection occurs primarily through the formation of crystallization bridges between the cement matrix of the first section and the cement paste of the second section. An especially stable material connection and thus overall high strength of the building system element according to the invention is achieved when the foaming out (first variant) or respectively the foaming on (second variant) of the second section takes place, as long as the concrete-type material of the first section has not yet fully crystallized or is not yet completely hardened.

The method according to the invention for production of the building system element described further above comprises the following method steps:
a) Distributing of solid particles, in particular of compact solid particles, in a first cement paste;
b) Shaping the first cement paste containing the solid particles into a first section;
c) At least partially hardening the shaped first cement paste into a hardened first cement matrix with the solid particles distributed therein and fixed thereby;
d) Foaming of a second cement paste and/or admixing of a second cement paste with hollow solid particles;
e) Contacting the first section with the second cement paste; and
f) Allowing the second cement paste to harden into a foamed porous second cement matrix and/or porous second cement matrix admixed with the hollow solid particles.

Preferably used as compact solid particles in the first cement paste is sand and/or gravel, the sand having preferably particle sizes in the range of 0 to 4 mm (fine aggregate) and the gravel preferably particle sizes in the range of 4 to 32 mm (coarse aggregate).

In an especially advantageous embodiment, the method step d) takes place using the method described further above for production of the inventive building material according to the first or the second variant.

Preferably in step c) the surface turned toward the second section is left to harden only partially before this surface is contacted with the cement paste foam in step e) by foaming out (first variant) or respectively foaming on (second variant).

A significant advantage of the method according to the invention consists in its low energy consumption, since neither a firing nor a steam hardening is needed.

Further advantages, features and application possibilities of the invention become apparent from the description that now follows of some preferred embodiment examples with reference to the drawing, whereby

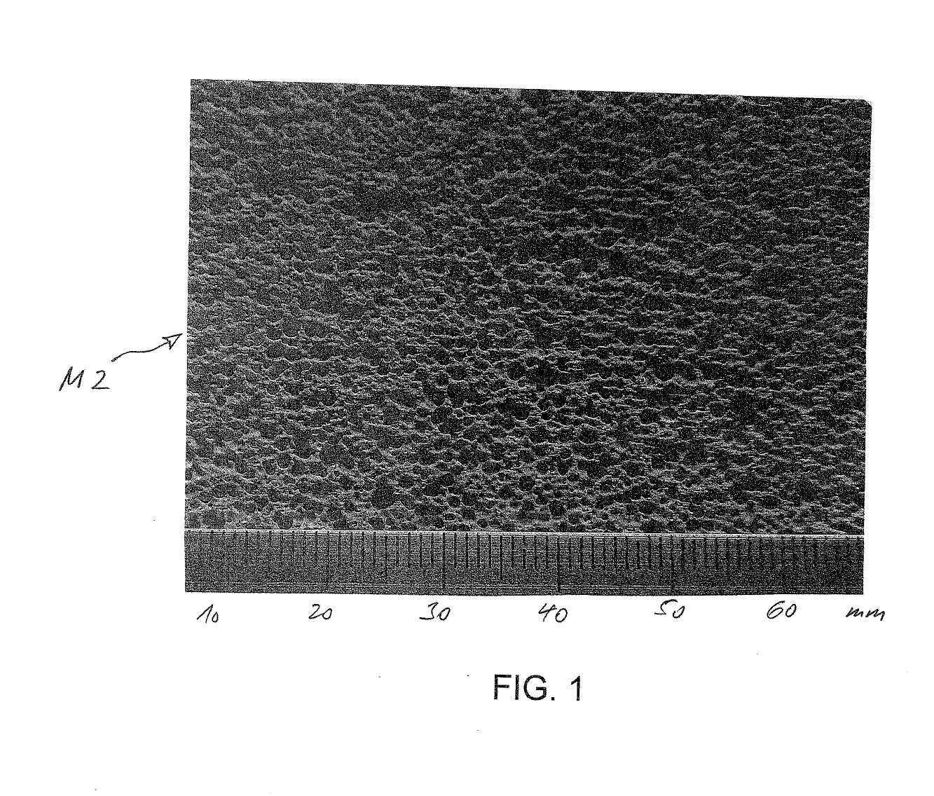

FIG. 1 shows a section through a building material according to the invention;

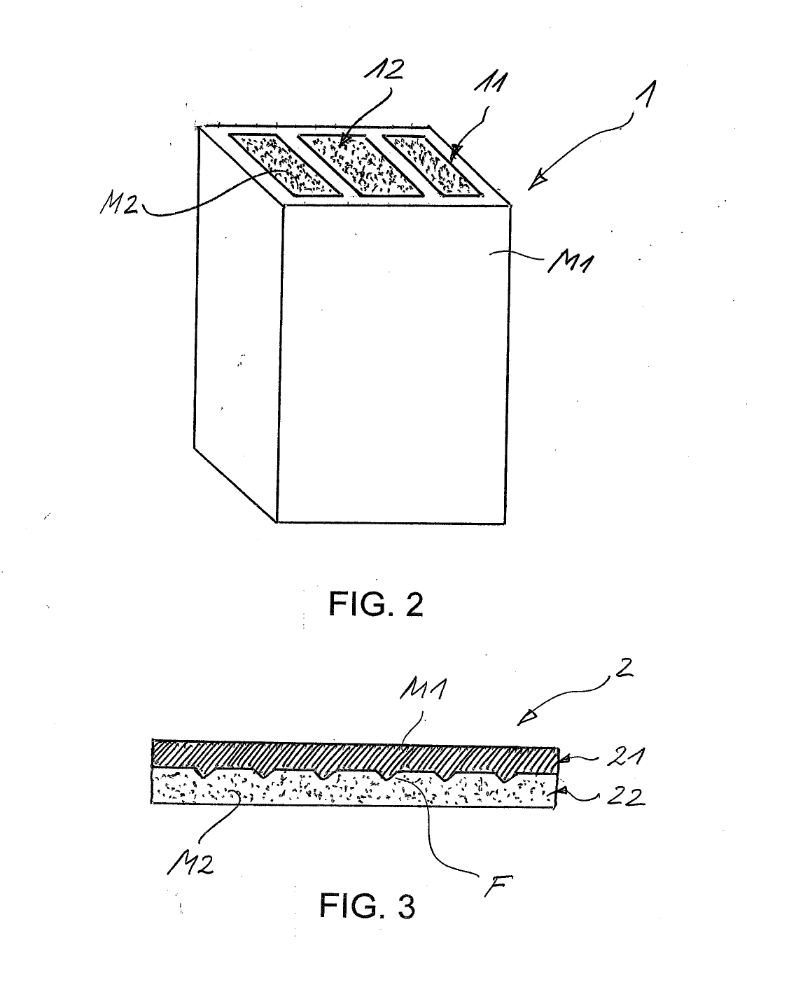

FIG. 2 is a schematic perspectival view of a first embodiment of a building system element according to the invention; and

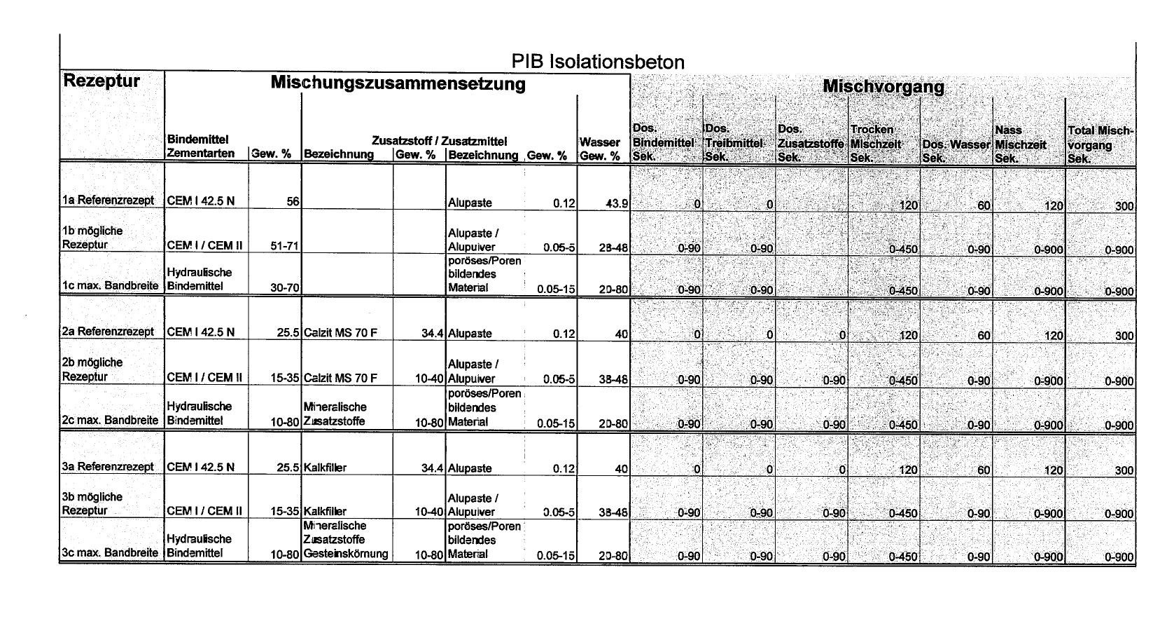

FIG. 3 is a diagrammatic sectional view of a second embodiment of a building system element according to the invention.

For production of the foamed second cement paste (cement paste foam) described further above, the following mixtures and procedures, not to be regarded in a limiting way, can be used.

### EXAMPLE 1

Used as binder is 56% by weight of a cement (Portland cement) of the class CEM I 42.5 N (according to standard SN EN 197-1: 2000), as expanding agent 0.12% by weight of aluminum paste and 43% by weight of water. At the point in time 0 (“second 0”) the cement and the aluminum paste or the aluminum powder is metered out and dry mixed. The dry mixing time is about 120 seconds. Now the water, weighed beforehand, is added while constantly mixing for another 60 seconds, and subsequently further wet-mixed. The wet mixing time is about 120 seconds.

The foaming begins distinctly after about 0.5 to 3 hours. After about 4 to 12 hours the foaming process is completed. The thus produced cement paste foam as building material, or respectively the building system element consisting thereof or containing it, can now be further processed (e.g. sawed into smaller blocks or plates). Although the foaming process can last up to about 12 hours, it is possible and expedient to begin this further processing already after 6 hours. Preferably the further processing takes place during a window of 6 to 24 hours after begin of the foaming. The hardened cement paste foam has a pore volume percentage of 20 to 70%, i.e. 1000 liters of hardened foam material contains 200 to 700 liters of pores, more than 80% of the total pore volume being in the form of pores whose diameter (“size”) is in the range of 0.1 to 3 mm (see FIG. 1).

### EXAMPLE 2

Used as binder is 25.5% by weight of a cement (Portland cement) of the class CEM I 42.5 N, 34.4% by weight of calcite MS 70 F as additive (calcite powder with a grain size distribution of 0 to 60 μm), 40% by weight of water and as expanding agent 0.12% by weight of aluminum paste.

At the point in time 0 (“second 0”), one begins to feed the cement, the aluminum paste and the additive into a mixing vessel.

At the point in time 120 seconds (dry mixing time) one begins to add the water for 60 seconds during further mixing, after which wet mixing is carried out for a further 120 seconds (wet mixing time). The foaming again begins after about 0.5 to 3 hours, and after about 4 to 12 hours the foaming process is completed. The thus produced cement paste as building material, or respectively the building system element consisting thereof or containing it, can now be further processed (e.g. sawed into smaller blocks or plates). Although the foaming process can last up to about 12 hours, it is possible and expedient to begin this further processing already after 6 hours, Preferably the further processing takes place during a window of 6 to 24 hours after begin of the foaming. The hardened cement paste foam has a pore volume percentage of 20 to 70%, i.e. 1000 liters of hardened foam material contains 200 to 700 liters of pores, again more than 80% of the total pore volume being in the form of pores whose diameter (“size”) is in the range of 0.1 to 3 mm (see FIG. 1).

### EXAMPLE 3

Like example 2, but used instead of calcite MS 70 F as additive, lime filler with a coarser grain distribution than calcite MS 70 F is used, and, to be more precise, calcite powder with a grain size distribution of 0 to 260 μm or calcite powder with a grain size distribution of 0 to 150 μm. The hardened cement paste foam has a pore volume percentage of 20 to 70%, i.e. 1000 liters of hardened foam material contains 200 to 700 liters of pores, once again 80% of the pore volume being in the form of pores whose diameter (“size”) is in the range of 0.1 to 3 mm (see FIG. 1).

For production of a building system element, the following mixtures and procedures, not to be regarded as limiting, can be used.

### EXAMPLE 4

The cement paste foam produced according to one of the examples 1, 2 or 3 is shaped e.g. in a hollow mold into a block-shaped formation. After a hardening time of 6 to 24 hours at room temperature or ambient temperature (about 10 to 25° C.), the production process is completed. The foamed formation can be cut and can be inserted into a cavity of a hollow concrete block or be glued in place (e.g. by means of adhesive cement). Alternatively, the foamed formation can be arranged on a concrete plate or be glued in place (e.g. by means of adhesive cement).

### EXAMPLE 5

With the cement paste foam according to one of the examples 1, 2 or 3, a hollow concrete block, produced beforehand, is foamed out (see FIG. 2). After a hardening time of 6 to 24 hours at room temperature or ambient temperature (about 10 to 25° C.) and a further processing, if applicable, the production process is completed,

### EXAMPLE 6

With the cement paste foam according to one of the examples 1, 2 or 3, a concrete plate, produced beforehand, is foamed on (see FIG. 3). After a hardening time of 6 to 24 hours at room temperature or ambient temperature (about 10 to 25° C.) and a further processing, if applicable, the production process is completed.

### EXAMPLE 7

Like example 6, but a multilayered formation is produced through repetition of the procedure of example 6. A first concrete plate is foamed on with the cement paste building material according to example 1, 2 or 3. A second concrete plate is pressed against this not yet hardened foamed cement paste building material. The pressing force thereby applied is selected in such a way that only a minimal compression of the layer made out of cement paste building material between the first and the second concrete plate takes place. This step can be repeated as often as desired until a sandwich plate is produced made up of concrete plates and cement foam plates following one after another in an alternating way. After a hardening time of 6 to 24 hours at room temperature or ambient temperature (about 10 to 25° C.) and a further processing, if applicable, the production process is completed.

### EXAMPLE 8

Like example 6, but a multilayered formation is produced through repetition of the procedure of example 6. The several concrete plates are fixed vertically with horizontal spacing apart from one another in a box. Subsequently the interim spaces between the concrete plates are foamed out with the not yet hardened foamed cement paste building material. After a hardening time of 6 to 24 hours at room temperature or ambient temperature (about 10 to 25° C.) and a further processing, if applicable, the production process is completed.

Shown enlarged in FIG. 1 is a section through a building material according to the invention (cement paste foam) next to a scale with millimeter graduation (ruler), which building material was produced according to the invention, e.g. according to example 1, 2 or 3. It can be seen that the building material (cement paste foam) has a pore volume percentage of 20 to 70%, a majority of more than 80% of the total pore volume being in the form of pores whose diameter is in the range of 0.1 to 3 mm.

For the thus produced building material shown in section in FIG. 1, a density of 564 kg/m³ and a thermal conductivity of 0.146 W/(m·K) were determined.

Shown schematically in a perspectival view in FIG. 2 is a first embodiment (hollow block formation) of a building system element according to the invention. The building system element 1 has a first section 11 in the form of a hollow block formation with a multiplicity of cavities as well as a second section 12 in the region of the multiplicity of cavities of the first section. These cavities are filled with the foamed cement paste M2 or the cement paste M2 intermixed with hollow solid particles and hardened. This embodiment is a hollow concrete block with cement paste foaming out.

Shown schematically in a sectional view in FIG. 3 is a second embodiment (plate formation) of a building system element according to the invention. The building system element 2 has a first section 21 in the form of a first plate formation and a second section 22 in the form of a second plate formation. The first section 21 and the second section 22 are in each case fixed to one another by a large face. The second section 22 is formed by foaming on to the first section 21. Formations F are formed on the large face of the first section, in order to strengthen the connection between the two sections 21, 22. These formations F can be made as nubs or as ribs. This configuration makes possible a material-bonding and formfitting connection between the two sections 21, 22. This embodiment is a concrete plate with foaming on using cement foam.

Listed in the table, by way of example, are mixture compositions as well as mixing procedures for various compositions.

1. A method for producing a building material, which method has the following steps:
i) Combining
10 to 80% by weight of a cement or respectively hydraulic binder,
10 to 80% by weight of a mineral additive,
20 to 80% by weight of water, and
0.05 to 15% by weight of a porous and/or pore-forming material, the sum of the individual combined elements making up 100% by weight; and
ii) mixing of the combined components,
wherein the combined components are mixed for 1 and 15 minutes, the dry mixing time before the addition of the water being 0 to 7.5 minutes and the wet mixing time after addition of the water being 0 to 15 minutes.

2. The method for producing a building material according to claim 1, wherein the material of the mineral additive has a grain size distribution in the range of 0 to 200 μm.

3. The method according to claim 1, characterized by:
i) combining
15 to 35% by weight of a cement of the class CEM I or of the class CEM II,
10 to 40% by weight of a pulvirulent mineral additive,
38 to 48% by weight of water, and
0.05 to 5% by weight of aluminum paste and/or aluminum powder.

4. A building material (M2), wherein it was produced by means of a method according to claim 1, it has a pore volume percentage of 20 to 70%, and a majority of 70 to 95%, in particular more than 80%, of the total pore volume is in the form of pores whose diameter is in the range of 0.1 to 5 mm.

5. The building material (M2) according to claim 4, wherein the majority of the total pore volume is in the form of pores whose diameter is in the range of 0.2 to 2 mm.

6. The building material according to claim 4, wherein the building material has a density in the range of 400 to 800 kg/m³ and preferably in the range of 500 to 600 kg/m³.

7. The building material according to claim 4, wherein the building material has a thermal conductivity in the range of 0.1 to 0.2 W/(m·K) and preferably in the range of 0.12 to 0.16 W/(m·K).

8. A building system element (1; 2) with a first section (11; 21), containing in particular compact solid particles distributed in a hardened cement matrix (M1) and fixed thereby and a second section (12; 22) containing pores distributed in a hardened cement matrix (M2), the first section (11; 21) being connected to the second section (12; 22), the second section (12; 22) being formed as porous cement matrix (M2) by foamed cement paste and/or cement paste intermixed with hollow solid particles and subsequently hardened, wherein the cement paste has a pore volume percentage of 20 to 70%, and a majority of 70 to 95%, in particular more than 80%, of the total pore volume is in the form of pores whose diameter is in the range of 0.1 to 5 mm, preferably in the range of 0.2 to 2 mm.

9. The building system element (1; 2) according to claim 8, wherein the cement paste contains solid particles with a grain size distribution in the range of 0 to 200 μm.

10. The building system element (1; 2) according to claim 8, wherein the first section (11; 21) is a composite of stone particles or respectively aggregates and cement having in particular grit, gravel, round grained sand or crushed sand or mixtures thereof.

11. The building system element (1; 2) according to claim 8, wherein admixed with the hardened cement paste is rock flour, in particular calcium carbonate.

12. The building system element (1; 2) according to claim 8, wherein the hardened cement paste is foamed by physical and/or chemical expanding agents.

13. The building system element (1) according to claim 8, wherein the first section (11) is in the form of a hollow block shape with one or more cavities, and the second section (12) is formed by the one or more cavities which is, or respectively are, filled with the foamed and hardened cement paste (M2) and/or the cement paste admixed with the hollow solid particles and hardened.

14. The building system element (2) according to claim 8, wherein the first section (21) is in the form of a first plate formation and the second section (22) is in the form of a second plate formation, which are each fixed to one another by one of their large faces.

15. A method for production of a building system element according to claim 8, which method has the following method steps:
a) Distributing of solid particles, in particular of compact solid particles, in a first cement paste;
b) Shaping the first cement paste containing the solid particles into a first section;
c) At least partially hardening the shaped first cement paste into a hardened first cement matrix with the solid particles distributed therein and fixed thereby;
d) Foaming of a second cement paste and/or admixing of a second cement paste with hollow or porous solid particles;
e) Contacting the first section with the second cement paste; and
f) Allowing the second cement paste to harden into a foamed second cement matrix and/or porous second cement matrix admixed with the hollow solid particles,
wherein the method step d) takes place using a method claim 1.
